(19) United States
(12) Patent Application Publication
(10) Pub. No.: US 2026/0002097 A1
(43) Pub. Date: Jan. 1, 2026

(54) TEXTILE ARTICLES FOR TUMBLE-DRYING

(71) Applicant: Firmenich SA, Satigny (CH)

(72) Inventors: Rachel COATES, Plainsboro, NJ (US); Robert KNAB, Plainsboro, NJ (US)

(21) Appl. No.: 18/575,300

(22) PCT Filed: Jun. 28, 2022
(86) PCT No.: PCT/EP2022/067747

§ 371 Date: Dec. 28, 2023

Related U.S. Application Data
(60) Provisional application No. 63/215,556, filed on Jun. 28, 2021.

(30) Foreign Application Priority Data
Jul. 15, 2021 (EP) 21185796.6

(51) Int. Cl. C11D 3/50; C11D 3/34; C11D 17/04; D06M 13/00; D06M 13/03; D06M 13/13; D06M 13/144; D06M 13/224; D06M 13/228; D06M 13/252; D06M 13/342; D06M 101/06

(52) U.S. Cl. CPC C11D 3/505; C11D 3/3427; C11D 17/047; D06M 13/005; D06M 13/03; D06M 13/13; D06M 13/144; D06M 13/224; D06M 13/2246; D06M 13/228; D06M 13/252; D06M 13/342; D06M 2101/06

(57) ABSTRACT

The present invention relates to a textile article comprising a pro-perfume compound that can be used for tumble drying. The present invention further relates to a method for the preparation of the textile article, and the use of the textile article for improving, enhancing, conferring and/or modifying the fragrance impression and/or fragrance intensity of a garment during tumble-drying.

### TECHNICAL FIELD

The present invention relates to a textile article comprising a pro-perfume compound that can be used for tumble drying. The present invention further relates to a method for the preparation of the textile article, and the use of the textile article for improving, enhancing, conferring and/or modifying the fragrance impression and/or fragrance intensity of a garment during tumble-drying.

### BACKGROUND OF THE INVENTION

A well-known commercial product in the laundry care industry is the dryer sheet. In use, the consumer typically uses at least one sheet in the drying cycle of the laundering process. A dryer sheet is commonly textile based, wherein the textile material carries one or more ingredients to impart desired benefits to the clothing during the tumble-drying process. These ingredients may be, for example, perfumes, anti-static agents, dye transfer inhibitors, whitening agents, enzymes, stain repellents, wrinkle reducing agents, fabric softener agents, and the like.

One major factor for customer satisfaction is that the dryer sheet provides the clothing with a pleasant fragrance impression of high intensity during the tumble-drying process that lasts as long as possible, i.e. the pleasant fragrance impression should still persist as long as possible after the tumble-drying process.

This objective is challenging, as high temperatures and simultaneous mechanical agitation during the tumble-drying process significantly affect the stability and longevity of many perfume compounds. Hence, a pleasant fragrance impression of the laundry may be perceived directly after the tumble-drying process, but said effect may not be sufficiently intense and/or long-lasting.

One way to tackle the above-mentioned objective is to encapsulate the perfume compounds within a carrier material before the perfume compounds are incorporated into the dryer sheet. In encapsulated form, the perfume compounds can withstand fairly harsh conditions applied during tumble-drying, and the encapsulated perfumes applied onto the clothing during tumble-drying may not be released immediately, but rather successively, which results in a prolonged fragrance perception, wherein the fragrance can often still be perceived after several days and even months. However, the encapsulation of perfuming ingredients may be laborious and costly.

Therefore, other solutions are desired to improve and prolong the fragrance impression that is provided to clothing during the tumble-drying process.

### BRIEF DESCRIPTION OF THE FIGURE

FIG. 1. Overall fragrance intensity of towels dried with a non-perfumed dryer sheet and towels dried with a perfumed dryer sheet.

### DETAILED DESCRIPTION OF THE INVENTION

The present invention relates to a textile article comprising a pro-perfume compound,
wherein the pro-perfume compound is a compound of formula

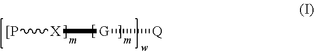

wherein:
a) w represents an integer from 1 to 10000;
b) n represents 1 or 0;
c) m represents an integer from 1 to 6;
d) P represents a hydrogen atom or a radical susceptible of generating an odoriferous α,β-unsaturated ketone, aldehyde or carboxylic ester and is represented by the formula

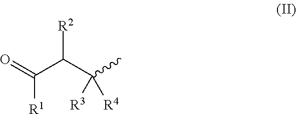

in which the wavy line indicates the location of the bond between said P and X; R¹ represents a hydrogen atom, a C₁ to C₆ alkoxyl radical or a C₁ to C₁₅ linear, cyclic or branched alkyl, alkenyl or alkadienyl radical, optionally substituted by one to four C₁ to C₄ alkyl groups; and
R², R³ and R⁴ represent independently of each other a hydrogen atom, an aromatic ring, or a C₁ to C₁₅ linear, cyclic or branched alkyl, alkenyl or alkadienyl radical, possibly substituted by C₁ to C₄ alkyl groups; or two, or three, of the groups R¹ to R⁴ are bonded together to form a saturated or unsaturated ring having 5 to 20 carbon atoms and including the carbon atom to which said R¹, R², R³ or R⁴ groups are bonded, this ring being possibly substituted by C₁ to C₈ linear, branched or cyclic alkyl or alkenyl groups; and with the proviso that at least one of the P groups is of the formula (II) as defined hereinabove;
e) X represents, independently from each other, a functional group selected from the group consisting of the formulae i) to xiv):

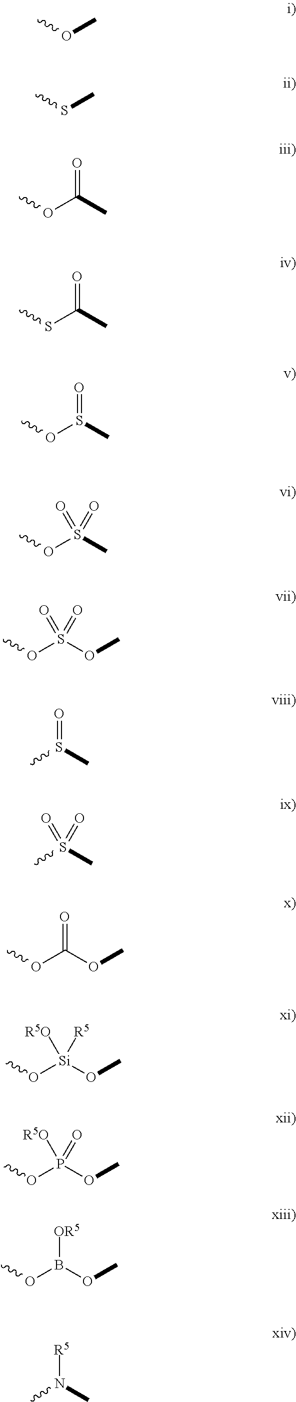

in which formulae the wavy lines are as defined previously and the bold lines indicate the location of the bond between said X and G, and R⁵ represents a hydrogen atom, a C₁ to C₂₂, saturated or unsaturated, alkyl group or an aryl group, possibly substituted by C₁ to C₆ alkyl or alkoxyl groups or halogen atoms; and with the proviso that X may not exist when P represents a hydrogen atom;
f) G represents a multivalent radical (with a m+1 valence) derived from cyclic, linear, alicyclic or branched alkyl, cyclic, linear, alicyclic or branched alkenyl, phenyl, alkylphenyl or alkenylphenyl hydrocarbon radical having from 1 to 22 carbon atoms, said hydrocarbon radical being possibly substituted and containing from 1 to 10 functional groups selected from the group consisting of halogens, alcohols, ethers, esters, ketones, aldehydes, carboxylic acids, thiols, thioethers, amines, quaternary amines and amides; and
g) Q represents a hydrogen atom (in which case w=1 and n=1), or represents a polymer or co-polymer selected from the group consisting of poly(alkylimine) s, peptides (e.g. lysine) or polysaccharides selected from the group consisting of cellulose, cyclodextrins and starches, or cationic quaternized silicon polymers, or still a polymer or random co-polymer derived from monomeric units selected from the group consisting of the formulae A-1), A-2), A-3), B-1), B-2), C-1), C-2), and C-3):

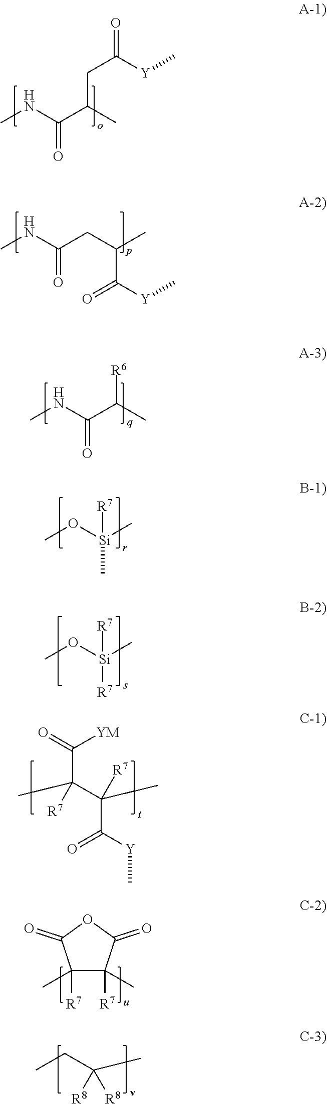

wherein the hatched lines indicate the location of the bond between said monomeric unit and G;
Y represents an oxygen or sulfur atom or a NR⁷ group;
o, p, q, r, s, t, u and v all represent independent of each other fractions between 0 and 1, with o+p+q=1, r+s=1 and t+u+v=1 and with the proviso that either o or p, as well as r and t are not equal to 0;
R⁶ represents a hydrogen atom or a side chain from a natural or unnatural amino acid, such as glycine, alanine, phenylalanine, arginine, histidine, lysine, aspartic acid, glutamic acid, cysteine, methionine, glutamine, asparagine, threonine, serine, leucine, isoleucine, valine, tyrosine or tryptophan;
R⁷ represents, simultaneously or independently, a hydrogen atom or a C₁-C₁₆ hydrocarbon group;
R⁸ represents, simultaneously or independently of each other
   a hydrogen or halide atom;
   a C₁-C₆ hydrocarbon group optionally comprising from 1 to 4 heteroatoms selected from the group consisting of oxygen and sulfur atoms;
   a carboxylic group of formula COOR*, wherein R* represents a hydrogen atom, a C₁-C₆₀ alkyl or alkenyl group optionally comprising from 1 to 30 oxygen atoms;
   a OR⁷ group or a COR⁷ group; or
   a pyrrolidone unit, connected by the nitrogen atom; and
M represents a hydrogen atom, an alkali or earth alkali metal ion.

The present invention relates to a textile article comprising a pro-perfume compound according to formula (I).

In a particular embodiment, the textile article is suitable for tumble drying.

In a particular embodiment, the textile article is a tumble dryer sheet, a dryer ball, a dryer sachet or a wipe. Preferably, the textile article is a tumble dryer sheet.

In a particular embodiment, the textile article comprises a textile carrier layer and a non-textile coating layer.

The textile carrier layer represents the basis structure of the textile article and comprises, preferably consists of, woven and/or non-woven fabric.

Preferably, the textile carrier layer comprises, preferably consists of, non-woven fabric. Non-woven fabric may comprise bonded fibrous or filamentous products having a web or carded fiber structure (where the fiber strength is suitable to allow carding), or, alternatively, may comprise fibrous mats in which the fibers or filaments are distributed haphazardly or in random array (i.e. an array of fibers in a carded web wherein partial orientation of the fibers is frequently present, as well as a completely haphazard distributional orientation), or substantially aligned. The fibers or filaments may be natural (e.g. wool, silk, jute, hemp, cotton, linen, sisal, or ramie) or synthetic (e.g. rayon, cellulose ester, polyvinyl derivatives, polyolefins, polyamides, or polyesters). The non-woven textile carrier layer may be made by any method readily selected by a person skilled in the art. Examples include the methods disclosed in U.S. Pat. No. 5,246,603.

The textile carrier layer may be configured to provide a desired physical property, such as, for example, absorbency, tensile strength, thickness and the like. For example, a desired absorbency may be achieved by building up the thickness of the textile carrier layer, i.e., by superimposing a plurality of carded webs or mats to a thickness adequate to obtain the necessary absorbent properties, or by allowing a sufficient thickness of the fibers to deposit on the screen.

The non-textile coating layer represents a coating that covers at least part of the surface of the textile carrier layer, preferably covers the whole surface of the textile carrier layer. The non-textile coating layer is not textile based, i.e. it does not comprise woven and/or non-woven fabric.

Preferably, the weight of the coating layer amounts to 43 to 75 wt. %, based on the total weight of the textile article.

In a particular embodiment, the non-textile coating layer comprises a softening agent. Preferably, the softening agent is methyl bis[ethyl(tallowate)]-2-hydroxyethyl ammonium methyl sulfate.

In a particular embodiment, the pro-perfume compound according to formula (I) is present in the textile carrier layer and/or in the non-textile coating layer.

Preferably, the pro-perfume compound according to formula (I) is present in at least the non-textile coating layer, more preferably the pro-perfume compound according to formula (I) is only present in the coating layer. Thereby, the pro-perfume compound according to formula (I) may be present on the surface of the non-textile coating layer and/or within the coating layer, i.e. the pro-perfume compound may be incorporated within the coating layer.

In this regard, the pro-perfume compound can be sprayed on top of the coating layer to achieve that the pro-perfume compound is present on the surface of the coating layer.

Moreover, the pro-perfume compound can be incorporated within the coating layer by e.g. adding the pro-perfume compound to the coating layer in molten form before the coating layer is applied on the textile carrier layer.

According to the invention, the textile article comprises a pro-perfume compound according to formula (I).

A pro-perfume or pro-fragrance is a compound that is able to release one, two or more perfume compounds, also termed PRMs (perfumery raw materials), upon external influence in a way that prolongs the perfuming effect of the PRMs. The release of the one or more perfume compounds is based on the cleavage of chemical bonds in the pro-perfume compound.

In a particular embodiment, the pro-perfume compound according to formula (I) releases one, two, or three perfume compounds. Preferably, the pro-perfume compound of formula (I) releases one perfume compound.

A “perfume compound” or “perfumery raw material” is a compound, which is used as an active ingredient in perfuming preparations or compositions in order to impart a hedonic effect; i.e. it is used for the primary purpose of conferring or modulating a pleasant odor. In other words, a compound to be considered as being a perfuming ingredient must be recognized by a skilled person in the art of perfumery as being able to impart or modify the odor of a composition in a positive or pleasant way, and not just as having an odor.

The external influence that triggers the release of perfume compounds from the pro-perfume compound according to formula (I) may be the exposure to light, air (ambient air)/oxygen, heat, moisture, or to an enzyme.

By “light”, any form of electromagnetic radiation is meant, which is not limited to any particular wavelength. The release of PRMs from the pro-perfume compound is usually more effective at lower wavelengths (higher energy input).

In a particular embodiment, the pro-perfume compound according to formula (I) releases the perfume compound(s) by the exposure to light.

For the sake of clarity, by the expression “ambient air”, or the similar, it is meant the normal meaning understood by a person skilled in the art, i.e. the oxidation occurs at room temperature, under air and atmospheric pressure. In other words, the environment wherein the compound is oxidized is air. Herewith it is understood, that the pro-perfume is oxidized in ambient air. In particular, it is understood that the pro-perfume does not necessarily require a pure oxygen environment, heat or catalyst to be oxidized.

In a particular embodiment, the pro-perfume compound according to formula (I) releases the perfume compound(s) by exposure to air (ambient air)/oxygen.

By “heat”, it is meant any energy input that is caused by increased temperature. The temperature to be applied is not limited to a particular temperature range, but rather depends on the individual pro-perfume. It lies within the knowledge of a skilled person to determine appropriate temperatures.

In a particular embodiment, the pro-perfume compound according to formula (I) releases the perfume compound(s) by exposure to heat.

The external influence triggering the release of PRMs from the pro-perfume compound may also be based upon the exposure to moisture. This requires that the pro-perfume compound shows chemical bonds that are susceptible to water-induced cleavage. It lies within the knowledge of a skilled person to identify pro-perfume compounds having chemical bonds that are susceptible to water-induced cleavage.

In a particular embodiment, the pro-perfume compound according to formula (I) releases the perfume compound(s) by exposure to moisture.

The external influence triggering the release of PRMs from the pro-perfume compound may also be based on the exposure to one or more enzymes. This requires that the pro-perfume compound shows chemical bonds that can be efficiently cleaved in the presence of enzymes. It lies within the knowledge of a skilled person to determine which chemicals bonds can effectively be cleaved by a certain type of enzyme.

In a particular embodiment, the pro-perfume compound according to formula (I) releases the perfume compound(s) by exposure to one or more enzymes.

In a particular embodiment, the pro-perfume compound is prompted to release perfumery raw materials not only based on one type of external influence as mentioned above, but based on two or more of the external influences mentioned above simultaneously or independently from each other. However, for every pro-perfume compound there commonly exists one or two types of release mechanism that are particularly efficient or superior compared to other types that may theoretically be envisaged. It lies well within the knowledge of a skilled person to determine the main types of release mechanism for existing pro-perfumes.

In a particular embodiment, the textile article comprises a pro-perfume compound according to formula (I) that releases the perfume compound(s) upon exposure to air (ambient air)/oxygen and moisture.

In a particular embodiment, the textile article comprises at least one further pro-perfume compound next to the pro-perfume compound according to formula (I). The textile article may thus comprise one, two, three, four, five, or more, further pro-perfume compounds next to the pro-perfume compound according to formula (I). The one or more further pro-perfume compound(s) can also be pro-perfume compounds falling within formula (I). The further pro-perfume compounds may release PRMs by the same release mechanism as the pro-perfume compound according to formula (I) or by another release mechanism. Under release mechanism, the external influence is understood that triggers the release of PRMs from the pro-perfume compound as given above. Preferably, the at last one further pro-perfume compound is selected from the group consisting of 2-phenylethyl oxo(phenyl)acetate, 3,7-dimethylocta-2,6-dien-1-yl oxo(phenyl)acetate, (Z)-hex-3-en-1-yl oxo(phenyl)acetate, 3,7-dimethyl-2,6-octadien-1-yl hexadecanoate, bis(3,7-dimethylocta-2,6-dien-1-yl) succinate, (2E,6Z)-2,6-nonadienyl hexadecanoate, (2E,6Z)-2,6-nonadien-1-yl tetradecanoate, (2E,6Z)-2,6-nonadien-1-yl dodecanoate, (2-((2-methylundec-1-en-1-yl)oxy)ethyl)benzene, 1-methoxy-4-(3-methyl-4-phenethoxybut-3-en-1-yl)benzene, (3-methyl-4-phenethoxybut-3-en-1-yl)benzene, 1-(((Z)-hex-3-en-1-yl)oxy)-2-methylundec-1-ene, (2-((2-methylundec-1-en-1-yl)oxy) ethoxy)benzene, 2-methyl-1-(octan-3-yloxy) undec-1-ene, 1-methoxy-4-(1-phenethoxyprop-1-en-2-yl)benzene, 1-methyl-4-(1-phenethoxyprop-1-en-2-yl)benzene, 2-(1-phenethoxyprop-1-en-2-yl) naphthalene, (2-phenethoxyvinyl)benzene, 2-(1-((3,7-dimethyloct-6-en-1-yl)oxy) prop-1-en-2-yl) naphthalene, (2-((2-pentylcyclopentylidene) methoxy)ethyl)benzene, 4-allyl-2-methoxy-1-((2-methoxy-2-phenylvinyl)oxy)benzene, (2-((2-heptylcyclopentylidene) methoxy)ethyl)benzene, 1-methoxy-4-(1-phenethoxyprop-1-en-2-yl)benzene, (2-((2-methyl-4-(2,6,6-trimethylcyclohex-1-en-1-yl) but-1-en-1-yl)oxy)ethyl)benzene, 1-methoxy-4-(2-methyl-3-phenethoxyallyl)benzene, (2-((2-isopropyl-5-methylcyclohexylidene) methoxy)ethyl)benzene, 1-isopropyl-4-methyl-2-((2-pentylcyclopentylidene) methoxy)benzene, 2-methoxy-1-((2-pentylcyclopentylidene) methoxy)-4-propylbenzene, 2-ethoxy-1-((2-methoxy-2-phenylvinyl)oxy)-4-methylbenzene, 3-methoxy-4-((2-methoxy-2-phenylvinyl)oxy)benzaldehyde, 1-isopropyl-2-((2-methoxy-2-phenylvinyl)oxy)-4-methylbenzene, 4-((2-(hexyloxy)-2-phenylvinyl)oxy)-3-methoxybenzaldehyde, or a mixture thereof.

In a particular embodiment, X represents a functional group selected from the group consisting of the formulae ii), iii), viii), ix) and xiv). In a particular embodiment, X represents the functional group of formula ii).

As “odoriferous a, B-unsaturated ketone, aldehyde or carboxylic ester”, the expression used in the definition of P, it is understood an α,β-unsaturated ketone, aldehyde or carboxylic ester, which is recognized by a skilled person as being used in perfumery as perfuming ingredient. In general, said odoriferous α,β-unsaturated ketone, aldehyde or carboxylic ester is a compound having from 8 to 20 carbon atoms, or even more preferably between 10 and 15 carbon atoms.

Similarly, it is not possible to provide an exhaustive list of the currently known odoriferous compounds, which can be used in the synthesis of the pro-perfume compounds of formula (I) as defined hereinabove and subsequently be released. However, the following can be named as preferred examples: alpha-damascone, beta-damascone, gamma-damascone, delta-damascone, alpha-ionone, beta-ionone, gamma-ionone, delta-ionone, beta-damascenone, 2-methyl-1-(2,6,6-trimethylcyclohex-3-en-1-yl) but-2-en-1-one, 1-[6-ethyl-2,6-dimethyl-3-cyclohexen-1-yl]-2-buten-1-one, 3-methyl-5-propyl-2-cyclohexen-1-one, 2-methyl-5-(1-propen-2-yl)-2-cyclohexen-1-one, 2,5-dimethyl-5-phenyl-1-hexen-3-one, 1-(5,5-dimethyl-1-cyclohexen-1-yl)-4-penten-1-one, 3,7-dimethylocta-2,6-dienal, 8-methyl-alpha-ionone or 10-methyl-alpha-ionone, 2-octenal, 1-(2,2,3,6-tetramethylcyclohexyl) but-2-en-1-one, 4-(2,2,3,6-tetramethylcyclohexyl) but-3-en-2-one, 2-cyclopentadecen-1-one, 4,4a-dimethyl-6-(1-propen-2-yl)-4,4a,5,6,7,8-hexahydro-2 (3H)-naphthalenone, (E)-3-phenylprop-2-enal (cinnamic aldehyde), 2,6,6-trimethylspiro[bicyclo[3.1.1]heptane-3,1′-cyclohexan]-2′-en-4′-one, ethyl 2,4-deca-dienoate, ethyl 2-octenoate, methyl 2-nonenoate, ethyl 2,4-undecadienoate, 4-methylpent-3-en-2-one, oct-2-en-4-one, and methyl 5,9-dimethyl-2,4,8-decatrienoate.

In a particular embodiment, P represents a radical selected from the group consisting of formulae (P-1) to (P-14), in the form of any one of its isomers:

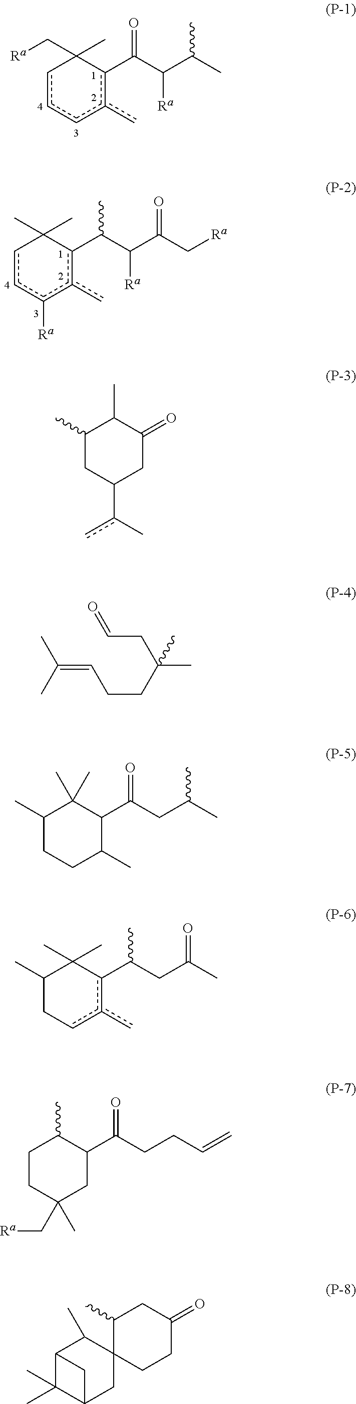

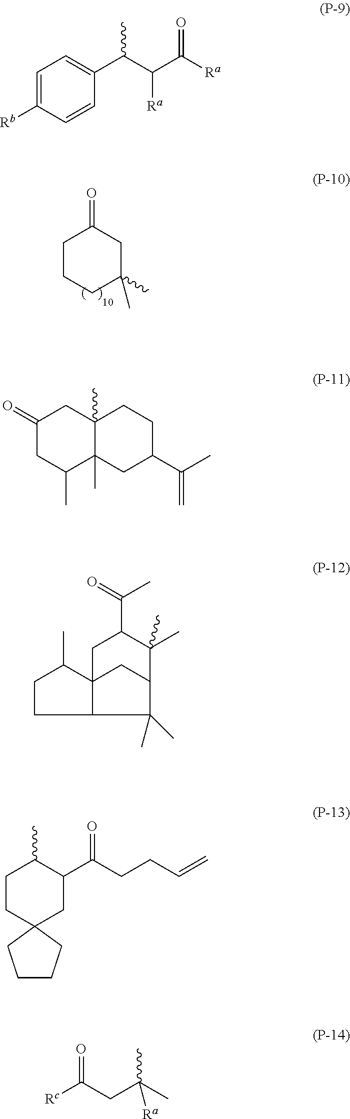

in which formulae the wavy lines have the meaning indicated above and the dotted lines represent a single or double bond, Ra being a hydrogen atom or a methyl group and Rb representing a hydrogen atom, a hydroxyl or methoxy group or a C₁-C₄ linear or branched alkyl group and R^{c} representing a hydrogen atom or a C₁-C₄ linear or branched alkyl group.

In a particular embodiment, P represents a radical selected from the group consisting of formulae

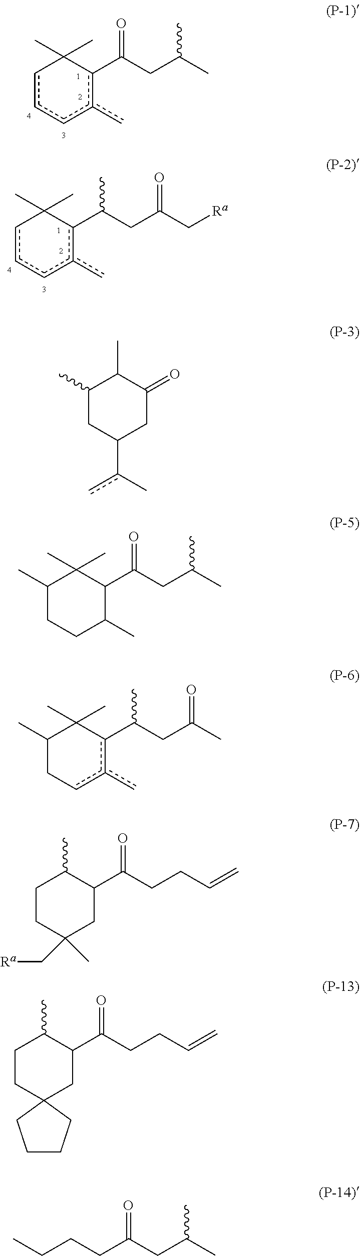

wherein the wavy lines have the meaning indicated above and the dotted lines represent a single or double bond, and Ra being a hydrogen atom or a methyl group.

In a particular embodiment, P represents a radical selected from the group consisting of formulae (P-1), (P-2), (P-1)′, (P-2)′, (P-3), (P-7), (P-13), (P-14) or (P-14)′ as defined above. Preferably, P represents a radical selected from the group consisting of formulae (P-1), (P-1)′, (P-2), (P-2)′, (P-3) or (P-14)′ as defined above.

In a particular embodiment, G may represent a divalent cyclic, linear, acyclic or branched alkyl, alkenyl, alkandienyl or alkylbenzene hydrocarbon radical having from 1 to 22 carbon atoms, said hydrocarbon radical being possibly substituted and containing from 1 to 10 functional groups selected from the group consisting of ethers, esters, ketones, aldehydes, carboxylic acids, thiols, thioethers, amines, quaternary amines and amides.

In a particular embodiment, G represents a divalent linear or branched alkyl or alkenyl hydrocarbon radical having from 1 to 22 carbon atoms, said hydrocarbon radical being possibly substituted and containing from 1 to 5 functional groups selected from the group consisting of ethers, esters, ketones, aldehydes, carboxylic acids, thiols, thioethers, amines, quaternary amines and amides.

In a particular embodiment, G represents a divalent linear or branched alkyl or alkenyl hydrocarbon radical having from 2 to 15 carbon atoms, said hydrocarbon radical being possibly substituted and containing from 1 to 2 functional groups selected from the group consisting of ethers and esters.

In a particular embodiment, G represents a divalent linear alkyl or alkenyl hydrocarbon radical having from 3 to 15 carbon atoms, said hydrocarbon radical being possibly substituted and containing one ester functional group.

In a particular embodiment, G represents a divalent linear alkyl hydrocarbon radical having from 3 to 14 carbon atoms.

In a particular embodiment, Q represents a hydrogen atom or a co-polymer comprising at least one repeating unit of formula B-1 as defined above.

In a particular embodiment, Q represents a hydrogen atom or a co-polymer comprising at least one repeating unit of formula B-1 and at least one repeating unit of formula B-2.

In a particular embodiment, R⁷ represents, simultaneously or independently, a hydrogen atom or a C₁₋₃ alkyl group. Preferably, R⁷ represents, simultaneously or independently, a hydrogen atom or a methyl or an ethyl group. More preferably, R⁷ represents, simultaneously or independently, a hydrogen atom or a methyl group.

In a particular embodiment, the pro-perfume compound according to formula (I) is characterized in that
w=1; n=1; m=1;
P represents a radical susceptible of generating an odoriferous α,β-unsaturated ketone, aldehyde and is represented by the formula,

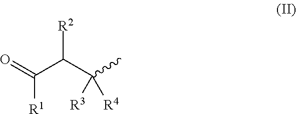

wherein R², R³ and R⁴ represent independently of each other a hydrogen atom, a C₆ to C₁₀ aromatic ring, or a C₁ to C₁₅ linear, cyclic or branched alkyl, alkenyl or alkadienyl radical, possibly substituted by C₁ to C₄ alkyl groups; or two, or three, of the groups R¹ to R⁴ are bonded together to form a saturated or unsaturated ring having 5 to 20 carbon atoms and including the carbon atom to which said R¹, R², R³ or R⁴ groups are bonded, this ring being possibly substituted by C₁ to C₈ linear, branched or cyclic alkyl or alkenyl groups;
X represents formula ii)
G represents a divalent radical derived from cyclic, linear or branched alkyl, alkenyl, phenyl, alkylphenyl or alkenylphenyl hydrocarbon radical having from 2 to 8 carbon atoms optionally comprising 1 or 2 oxygen, sulfur and/or nitrogen atoms
Q represents a polymer or random co-polymer derived from formula B-1), wherein R⁷ represents a C₁-C₁₆ hydrocarbon group.

In a particular embodiment, the pro-perfume compound according to formula (I) is a linear polysiloxane co-polymer comprising at least one repeating unit of formula

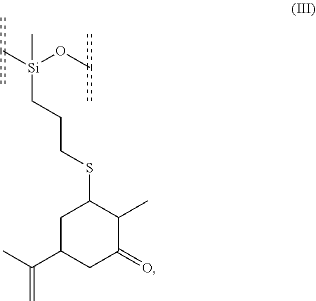

wherein the double hatched lines indicate the bonding to another repeating unit.

The pro-perfume of formula (III) releases 2-methyl-5-(prop-1-en-2-yl)cyclohex-2-en-1-one as fragrance compound, which is also known as carvone. Carvone exists in the form of two enantiomers, namely (R)-(−)-2-methyl-5-(1-propen-2-yl)-2-cyclohexen-1-one (L-carvone or carvone laevo) and(S)-(+)-2-methyl-5-(1-propen-2-yl)-2-cyclohexen-1-one (D-carvone or carvone dextro). The two enantiomers have been reported to have slightly different mint odor tonalities. Nevertheless, according to the invention, both enantiomers are expected to have a similar effect in view of the preparation of the co-polymer and the release efficiency.

According to the invention, carvone can either be used as a racemate or as a mixture enriched in either one of the two enantiomers. Preferably, a mixture enriched in carvone laevo is used.

In a particular embodiment, the pro-perfume compound is of formula (IV)

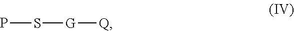

wherein P has the same meaning as defined above:
G represents a divalent radical derived from a linear or branched alkyl or alkenyl radical having from 2 to 15 carbon atoms, possibly substituted with one or more groups selected from the group consisting of —OR⁹, —NR⁹₂, —COOR⁹ and R⁹ groups, in which R⁹ represents a hydrogen atom or a C₁ to C₆ alkyl or alkenyl group; and
Q represents a hydrogen atom.

In a particular embodiment, the pro-perfume compound according to formula (I) is selected from the group consisting of the following formulae a) to d):

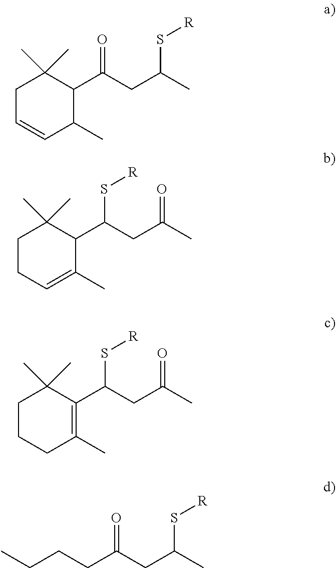

wherein R represents a C₁-C₂₀ alkyl or alkenyl group, preferably a C₆-C₁₆ alkyl or alkenyl group, more preferably a C₁₂ alkyl group.

The pro-perfume of formula a) releases delta-damascone as fragrance compound. Said pro-perfume may preferably be (+)-trans-3-(dodecylthio)-1-(2,6,6-trimethyl-3-cyclohexen-1-yl)-1-butanone. Delta-damascone is also known as 1-[(1RS,2SR)-2,6,6-trimethyl-3-cyclohexen-1-yl]-2-buten-1-one.

The pro-perfume of formula b) or c) releases ionone as fragrance compound. Said pro-perfume may be present as an isomeric mixture of formula b) and formula c). The isomeric mixture may have a weight ratio of formula b) and formula c) from 40:60 to 60:40. In particular, the isomeric mixture may have a weight ratio of formula b) and formula c) of about 55:45. In particular, said pro-perfume releases two isomers of ionone as fragrance compound.

In particular, the pro-perfume of formula b) releases alpha-ionone as fragrance compound. Said pro-perfume of formula b) may preferably be (+)-4-(dodecylthio)-4-(2,6,6-trimethyl-2-cyclohexen-1-yl)-2-butanone. Alpha-ionone is also known as (+)-(3E)-4-(2,6,6-trimethyl-2-cyclohexen-1-yl)-3-buten-2-one.

In particular, the pro-perfume of formula c) releases beta-ionone as fragrance compound. Said pro-perfume of formula c) may preferably be (+)-4-(dodecylthio)-4-(2,6,6-trimethyl-1-cyclohexen-1-yl)-2-butanone. Beta-ionone is also known as (3E)-4-(2,6,6-trimethyl-1-cyclohexen-1-yl)-3-buten-2-one.

The pro-perfume of formula d) releases oct-2-en-4-one as fragrance compound. Said pro-perfume may preferably be (+)-2-(dodecylthio) octan-4-one. Oct-2-en-4-one may be released as its (E)- or (Z)-isomers, or as mixtures thereof, with the (E)-isomer being preferred.

In a particular embodiment the pro-perfume compound according to formula (I) is selected from the group consisting of methyl or ethyl 2-(4-oxo-4-(2,6,6-trimethylcyclohex-3-en-1-yl) butan-2-ylamino)-3-(4-oxo-4-(2,6,6-trimethylcyclohex-3-en-1-yl) butan-2ylthio)propanate, methyl or ethyl 2-(4-oxo-4-(2,6,6-trimethylcyclohex-2-en-1-yl) butan-2-ylamino)-3-(4-oxo-4-(2,6,6-trimethylcyclohex-2-en-1-yl) butan-2-ylthio)propanate, methyl or ethyl 2-(2-oxo-4-(2,6,6-trimethylcyclohex-1-en-1-yl) butan-4-ylamino)-3-(2-oxo-4-(2,6,6-trimethylcyclohex-1-en-1-yl) butan-4-ylthio)propanate, methyl or ethyl 2-(2-oxo-4-(2,6,6-trimethylcyclohex-2-en-1-yl) butan-4-ylamino)-3-(2-oxo-4-(2,6,6-trimethylcyclohex-2-en-1-yl) butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 3-(dodecylsulfonyl)-1-(2,6,6-trimethylcyclohex-3-en-1-yl) butan-1-one, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-dodecylsulfanyl-5-methyl-heptan-4-one, 2-cyclohexyl-1-dodecylsulfanyl-hept-6-en-3-one, 3-(dodecylthio)-5-isopropenyl-2-methylcyclohexanone, 2-(dodecylthio)-4-octanone, 2-(dodecylsulfonyl) octan-4-one, 4-(dodecylthio)-4-methylpentan-2-one, methyl or ethyl N,S-bis(4-oxo-4-(2,6,6-trimethylcyclohex-3-en-1-yl) butan-2-yl)-L-cysteinate, methyl or ethyl S-(4-oxo-4-(2,6,6-trimethylcyclohex-3-en-1-yl) butan-2-yl)-L-cysteinate, 4-oxooctan-2-yl dodecanoate, and any mixtures thereof.

Preferably, the pro-perfume compound of formula (I) is selected from the group consisting of 3-(dodecylthio)-1-(2,6,6-trimethylcyclohex-3-en-1-yl) butan-1-one (Haloscent® D), 3-(dodecylthio)-1-(2,6,6-trimethylcyclohex-2-en-1-yl) butan-1-one, 4-(dodecylthio)-4-(2,6,6-trimethylcyclohex-2-en-1-yl) butan-2-one (Haloscent® I) and 4-(dodecylthio)-4-(2,6,6-trimethylcyclohex-1-en-1-yl) butan-2-one (Haloscent® I), 2-(dodecylthio)-4-octanone, 2-(dodecylsulfonyl) octan-4-one, 4-(dodecylthio)-4-methylpentan-2-one, methyl or ethyl N,S-bis(4-oxo-4-(2,6,6-trimethylcyclohex-3-en-1-yl) butan-2-yl)-L-cysteinate, methyl or ethyl S-(4-oxo-4-(2,6,6-trimethylcyclohex-3-en-1-yl) butan-2-yl)-L-cysteinate, 4-oxooctan-2-yl dodecanoate, or any mixtures thereof.

More preferably, the pro-perfume compound of formula (I) is 3-(dodecylthio)-1-(2,6,6-trimethylcyclohex-3-en-1-yl) butan-1-one (HaloScent® D), 4-(dodecylthio)-4-(2,6,6-trimethylcyclohex-2-en-1-yl) butan-2-one (HaloScent® I), 4-(dodecylthio)-4-(2,6,6-trimethylcyclohex-1-en-1-yl) butan-2-one (HaloScent® I), or a mixture thereof.

Yet more preferably, the pro-perfume compound of formula (I) is a mixture of 3-(dodecylthio)-1-(2,6,6-trimethylcyclohex-3-en-1-yl) butan-1-one (HaloScent® D), 4-(dodecylthio)-4-(2,6,6-trimethylcyclohex-1-en-1-yl) butan-2-one (HaloScent® I) and 4-(dodecylthio)-4-(2,6,6-trimethylcyclohex-2-en-1-yl) butan-2-one (HaloScent® I).

Most preferably, the pro-perfume compound of formula (I) is a mixture of 3-(dodecylthio)-1-(2,6,6-trimethylcyclohex-3-en-1-yl) butan-1-one (HaloScent® D) and 4-(dodecylthio)-4-(2,6,6-trimethylcyclohex-1-en-1-yl) butan-2-one (HaloScent® I).

In a particular embodiment, the pro-perfume compound is not comprised in the textile article based on the deposition of the pro-perfume compound during a washing process.

In a particular embodiment, the pro-perfume compound according to formula (I) is non-encapsulated. Non-encapsulated means that the pro-perfume compound according to formula (I) is not encapsulated within a polymeric carrier material before it is added to the textile article according to the invention.

In a particular embodiment, the pro-perfume compound according to formula (I) is dissolved in a solvent before it is added to the textile article. Examples of suitable solvents are butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethano, tri-ethyl citrate, ethanol, water/ethanol mixtures, limonene or other terpenes, isoparaffins such as those known under the trademark Isopar® (origin: Exxon Chemical), glycol ethers and glycol ether esters such as those known under the trademark Dowanol® (origin: Dow Chemical Company), hydrogenated castors oils such as those known under the trademark Cremophor® RH 40 (origin: BASF), or a mixture thereof. In said embodiment, the textile article thus also comprises such a solvent.

In a particular embodiment, the textile article comprises the pro-perfume compound in an amount of from 0.000086 to 1.875 wt. %, based on the total weight of the textile article, preferably from 0.000086 to 1.5 wt. %, more preferably from 0.000086 to 1 wt. %, even more preferably from 0.000086 to 0.75 wt. %, yet even more preferably from 0.001 to 0.375, most preferably from 0.0172 to 0.1875 wt. %.

In a particular embodiment, the pro-perfume compound according to formula (I) is present in the non-textile coating layer, wherein the pro-perfume compound is present in the coating layer in an amount of from 0.0002 to 2.5 wt. %, based on the total weight of the coating layer, preferably in an amount of from 0.0002 to 1 wt. %, more preferably in an amount of from 0.04 to 0.25 wt. %.

In a particular embodiment, the textile article further comprises a perfuming composition comprising
i) at least one ingredient selected from the group consisting of a perfumery carrier and a perfumery base; and
ii) optionally at least one perfumery adjuvant.

By “perfumery carrier” it is meant here a material which is practically neutral from a perfumery point of view, i.e. that does not significantly alter the organoleptic properties of perfuming ingredients. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly used in perfumery cannot be exhaustive. However, one can cite as non-limiting examples, solvents such as butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, Abalyn® (rosin resins, available from Eastman), benzyl benzoate, benzyl alcohol, 2-(2-ethoxyethoxy)-1-ethano, tri-ethyl citrate or mixtures thereof, which are the most commonly used or also naturally derived solvents like glycerol or various vegetable oils such as palm oil, sunflower oil or linseed oil. For the compositions which comprise both a perfumery carrier and a perfumery base, other suitable perfumery carriers than those previously specified, can be also ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company), or hydrogenated castors oils such as those known under the trademark Cremophor® RH 40 (origin: BASF).

Solid carrier is meant to designate a material to which the perfuming composition or some element of the perfuming composition can be chemically or physically bound. In general, such solid carriers are employed either to stabilize the composition, or to control the rate of evaporation of the compositions or of some ingredients. The use of solid carrier is of current use in the art and a person skilled in the art knows how to reach the desired effect. However, by way of non-limiting example of solid carriers, one may cite absorbing gums or polymers or inorganic material, such as porous polymers, cyclodextrins, dextrins, maltodextrins, wood based materials, organic or inorganic gels, clays, gypsum talc or zeolites.

As other non-limiting examples of solid carriers, one may cite encapsulating materials. Examples of such materials may comprise wall-forming and plasticizing materials, such as glucose syrups, natural or modified starches, hydrocolloids, cellulose derivatives, polyvinyl acetates, polyvinylalcohols, proteins or pectins, plant gums such as acacia gum (Gum Arabic), urea, sodium chloride, sodium sulphate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, carbohydrates, saccharides such as sucrose, mono-, di-, tri- and polysaccharides and derivatives such as chitosan, starch, cellulose, carboxymethyl methylcellulose, methylcellulose, hydroxyethyl cellulose, ethyl cellulose, propyl cellulose, polyols/sugar alcohols such as sorbitol, maltitol, xylitol, erythritol, and isomalt, polyethylene glycol (PEG), polyvinyl pyrrolidin (PVP), polyvinyl alcohol, acrylamides, acrylates, polyacrylic acid and related, maleic anhydride copolymers, amine-functional polymers, vinyl ethers, styrenes, polystyrenesulfonates, vinyl acids, ethylene glycol-propylene glycol block copolymers, vegetable gums, gum acacia, pectins, xanthanes, alginates, carragenans, citric acid or any water soluble solid acid, fatty alcohols or fatty acids and mixtures thereof, or yet the materials cited in reference texts such as H. Scherz, Hydrokolloide: Stabilisatoren, Dickungs-und Geliermittel in Lebensmitteln, Band 2 der Schriftenreihe Lebensmittelchemie, Lebensmittelqualität, Behr's Verlag Gmbh & Co., Hamburg, 1996. The encapsulation is a well-known process to a person skilled in the art, and may be performed, for instance, by using techniques such as spray-drying, agglomeration or yet extrusion; or consists of a coating encapsulation, including coacervation and complex coacervation technique.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycouryl, melamine, methylol melamine, methylated methylol melamine, guanazole and the like, as well as mixtures thereof. Alternatively one may use preformed resins alkylolated polyamines such as those commercially available under the trademark Urac® (origin: Cytec Technology Corp.), Cy Mel® (origin: Cytec Technology Corp.), Urecoll® or Luracoll® (origin: BASF).

Others resins one are the ones produced by the polycondensation of an a polyol, like glycerol, and a polyisocyanate, like a trimer of hexamethylene diisocyanate, a trimer of isophorone diisocyanate or xylene diisocyanate or a Biuret of hexamethylene diisocyanate or a trimer of xylene diisocyanate with trimethylolpropane (known with the tradename of Takenate®, origin: Mitsui Chemicals), among which a trimer of xylene diisocyanate with trimethylolpropane and a Biuret of hexamethylene diisocyanate.

Some of the seminal literature related to the encapsulation of perfumes by polycondensation of amino resins, namely melamine based resins with aldehydes includes represented by articles such as those published by K. Dietrich et al. Acta Polymerica, 1989, vol. 40, pages 243, 325 and 683, as well as 1990, vol. 41, page 91. Such articles already describe the various parameters affecting the preparation of such core-shell microcapsules following prior art methods that are also further detailed and exemplified in the patent literature. US 4′396′670, to the Wiggins Teape Group Limited is a pertinent early example of the latter. Since then, many other authors have enriched the literature in this field and it would be impossible to cover all published developments here, but the general knowledge in encapsulation technology is very significant. More recent publications of pertinency, which disclose suitable uses of such microcapsules, are represented for example by the article of H. Y. Lee et al. Journal of Microencapsulation, 2002, vol. 19, pages 559-569, international patent publication WO 01/41915 or yet the article of S. Bône et al. Chimia, 2011, vol. 65, pages 177-181.

The term “perfumery base” is understood as a composition comprising at least one perfume compound. The perfume compound has the same meaning as define above. A pro-perfume compound is not considered a perfume compound.

The nature and type of the perfume compounds present in the base do not warrant a more detailed description here, which in any case would not be exhaustive, the skilled person being able to select them on the basis of his general knowledge and according to the intended use or application and the desired organoleptic effect. In general terms, these perfuming co-ingredients belong to chemical classes as varied as alcohols, lactones, aldehydes, ketones, esters, ethers, acetates, nitriles, terpenoids, nitrogenous or sulphurous heterocyclic compounds and essential oils, and said perfuming co-ingredients can be of natural or synthetic origin.

Examples for perfume compounds commonly used in perfume formulations are:
Aldehydic ingredients: decanal, dodecanal, 2-methyl-undecanal, 10-undecenal, octanal, nonanal and/or nonenal;
Aromatic-herbal ingredients: eucalyptus oil, camphor, eucalyptol, 5-methyltricyclo[6.2.1.0˜2,7˜] undecan-4-one, 1-methoxy-3-hexanethiol, 2-ethyl-4,4-dimethyl-1,3-oxathiane, 2,2,7/8,9/10-Tetramethylspiro[5.5]undec-8-en-1-one, menthol and/or alpha-pinene;
Balsamic ingredients: coumarin, ethylvanillin and/or vanillin;
Citrus ingredients: dihydromyrcenol, citral, orange oil, linalyl acetate, citronellyl nitrile, orange terpenes, limonene, 1-p-menthen-8-yl acetate and/or 1,4 (8)-p-menthadiene; Floral ingredients: methyl dihydrojasmonate, linalool, citronellol, phenylethanol, 3-(4-tert-butylphenyl)-2-methylpropanal, hexylcinnamic aldehyde, benzyl acetate, benzyl salicylate, tetrahydro-2-isobutyl-4-methyl-4 (2H)-pyranol, beta ionone, methyl 2-(methylamino)benzoate, (E)-3-methyl-4-(2,6,6-trimethyl-2-cyclohexen-1-yl)-3-buten-2-one, (1E)-1-(2,6,6-trimethyl-2-cyclohexen-1-yl)-1-penten-3-one, 1-(2,6,6-trimethyl-1,3-cyclohexadien-1-yl)-2-buten-1-one, (2E)-1-(2,6,6-trimethyl-2-cyclohexen-1-yl)-2-buten-1-one, (2E)-1-[2,6,6-trimethyl-3-cyclohexen-1-yl]-2-buten-1-one, (2E)-1-(2,6,6-trimethyl-1-2,5-dimethyl-2-indanmethanol, 2,6,6-trimethyl-3-cyclohexen-1-yl)-2-buten-1-one, cyclohexene-1-carboxylate, 3-(4,4-dimethyl-1-cyclohexen-1-yl) propanal, hexyl salicylate, 3,7-dimethyl-1,6-nonadien-3-ol, 3-(4-isopropylphenyl)-2-methylpropanal, verdyl acetate, geraniol, p-menth-1-en-8-ol, 4-(1,1-dimethylethyl)-1-cyclohexyle acetate, 1,1-dimethyl-2-phenylethyl acetate, 4-cyclohexyl-2-methyl-2-butanol, amyl salicylate, high cis methyl dihydrojasmonate, 3-methyl-5-phenyl-1-pentanol, verdyl proprionate, geranyl acetate, tetrahydro linalool, cis-7-p-menthanol, propyl(S)-2-(1,1-dimethylpropoxy) propanoate, 2-methoxynaphthalene, 2,2,2-trichloro-1-phenylethyl acetate, 4/3-(4-hydroxy-4-methylpentyl)-3-cyclohexene-1-carbaldehyde, amylcinnamic aldehyde, 8-decen-5-olide, 4-phenyl-2-butanone, isononyle acetate, 4-(1,1-dimethylethyl)-1-cyclohexyl acetate, verdyl isobutyrate and/or mixture of methylionones isomers;
Fruity ingredients: gamma-undecalactone, 2,2,5-trimethyl-5-pentylcyclopentanone, 2-methyl-4-propyl-1,3-oxathiane, 4-decanolide, ethyl 2-methyl-pentanoate, hexyl acetate, ethyl 2-methylbutanoate, gamma-nonalactone, allyl heptanoate, 2-phenoxyethyl isobutyrate, ethyl 2-methyl-1,3-dioxolane-2-acetate, 3-(3,3/1, 1-dimethyl-5-indanyl) propanal, diethyl 1,4-cyclohexanedicarboxylate, 3-methyl-2-hexen-1-yl acetate, 1-[3,3-dimethylcyclohexyl] ethyl [3-ethyl-2-oxiranyl] acetate and/or diethyl 1,4-cyclohexane dicarboxylate;
Green ingredients: 2-methyl-3-hexanone (E)-oxime, 2,4-dimethyl-3-cyclohexene-1-carbaldehyde, 2-tert-butyl-1-cyclohexyl acetate, styrallyl acetate, allyl (2-methylbutoxy)acetate, 4-methyl-3-decen-5-ol, diphenyl ether, (Z)-3-hexen-1-ol and/or 1-(5,5-dimethyl-1-cyclohexen-1-yl)-4-penten-1-one;
Musk ingredients: 1,4-dioxa-5,17-cycloheptadecanedione, (Z)-4-cyclopentadecen-1-one, 3-methylcyclopentadecanone, 1-oxa-12-cyclohexadecen-2-one, 1-oxa-13-cyclohexadecen-2-one, (9Z)-9-cycloheptadecen-1-one, 2-{1S)-1-[(1R)-3,3-dimethylcyclohexyl] ethoxy}-2-oxoethyl propionate 3-methyl-5-cyclopentadecen-1-one, 1,3,4,6,7,8-hexahydro-4,6,6,7,8,8-hexamethyl-cyclopenta-g-2-benzopyrane, (1S,1′R)-2-[1-(3′,3′-dimethyl-1′-cyclohexyl) ethoxy]-2-methylpropyl propanoate, oxacyclohexadecan-2-one and/or (1S,1′R)-[1-(3′,3′-dimethyl-1′-cyclohexyl) ethoxycarbonyl] methyl propanoate; Woody ingredients: 1-[(1RS,6SR)-2,2,6-trimethylcyclohexyl]-3-hexanol, 3,3-dimethyl-5-[(1R)-2,2,3-trimethyl-3-cyclopenten-1-yl]-4-penten-2-ol, 3,4′-dimethylspiro[oxirane-2,9′-tricyclo[6.2.1.02,7] undec[4] ene, (1-ethoxyethoxy)cyclododecane, 2,2,9,11-tetramethylspiro[5.5]undec-8-en-1-yl acetate, 1-(octahydro-2,3,8,8-tetramethyl-2-naphtalenyl)-1-ethanone, patchouli oil, terpenes fractions of patchouli oil, Clearwood® (Origin: Firmenich SA), (1′R,E)-2-ethyl-4-(2′,2′,3′-trimethyl-3′-cyclopenten-1′-yl)-2-buten-1-ol, 2-ethyl-4-(2,2,3-trimethyl-3-cyclopenten-1-yl)-2-buten-1-ol, methyl cedryl ketone, 5-(2,2,3-trimethyl-3-cyclopentenyl)-3-methylpentan-2-ol, 1-(2,3,8,8-tetramethyl-1,2,3,4,6,7,8,8a-octahydronaphthalen-2-yl) ethan-1-one and/or isobornyl acetate; Other ingredients (e.g. amber, powdery spicy or watery): dodecahydro-3a,6,6,9a-tetramethyl-naphtho[2,1-b]furan and any of its stereoisomers, heliotropin, anisic aldehyde, eugenol, cinnamic aldehyde, clove oil, 3-(1,3-benzodioxol-5-yl)-2-methylpropanal, 7-methyl-2H-1,5-benzodioxepin-3 (4H)-one, 2,5,5-trimethyl-1,2,3,4,4a,5,6,7-octahydro-2-naphthalenol, 1-phenylvinyl acetate, 6-methyl-7-oxa-1-thia-4-azaspiro[4.4]nonan and/or 3-(3-isopropyl-1-phenyl) butanal.

In a particular embodiment, the at least one perfume compound is selected from the group consisting of isopropyl myristate, 1,4-dioxacycloheptadecane-5,17-dione, 1-oxa-12/13-cyclohexadecen-2-one, 2-(2-methyl-2-propanyl)cyclohexyl acetate, (3Z)-3-hexen-1-yl salicylate, (2E)-2-benzylideneoctanal, 1-(1,2,8,8-tetramethyl-1,3,4,5,6,7-hexahydronaphthalen-2-yl) ethanone, methyl 2-((1RS,2RS)-3-oxo-2-pentylcyclopentyl)acetate, 1,1-dimethyl-2-phenylethyl butanoate, 4-(4-hydroxyphenyl)-2-butanone, allyl heptanoate, (−)-(2E)-2-ethyl-4-[(1R)-2,2,3-trimethyl-3-cyclopenten-1-yl]-2-buten-1-ol, 3-ethoxy-4-hydroxybenzaldehyde, 4-methoxybenzaldehyde, (+−)-4-decanolide, (+−)-3,7-dimethyl-1,6-octadien-3-ol, (+−)-5-heptyldihydro-2 (3H)-furanone, tricyclo[5.2.1.0 (2,6)] dec-3/4-en-8-yl propanoate, (+−)-1,5-dimethyl-1-vinyl-4-hexenyl acetate, (10E)-oxacycloheptadec-10-en-2-one, dipropylene glycol, 3-pentyltetrahydro-2H-pyran-4-yl acetate, (+−)-(3E)-4-(2,6,6-trimethyl-1/2-cyclohexen-1-yl)-3-buten-2-one, 2-ethyl-3-hydroxy-4 (4h)-pyranone, ethyl 2-methyl-1,3-dioxolane-2-acetate, allyl 3-cyclohexylpropanoate, 1,1-dimethyl-2-phenylethyl acetate, methyl 2,4-dihydroxy-3,6-dimethylbenzoate, beta-pinene, (3E)-4-(2,6,6-trimethyl-1-cyclohexen-1-yl)-3-buten-2-one, (+−)-(2E)-1-(2,6,6-trimethyl-2-cyclohexen-1-yl)-2-buten-1-one, or any mixture thereof.

The at least one perfume compound according to the invention may not be limited to the above mentioned perfume compounds, and many other of these co-ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of perfumery.

The term “perfumery adjuvant” is understood as an ingredient capable of imparting additional added benefit such as a color, a particular light resistance, chemical stability and etc. A detailed description of the nature and type of adjuvant commonly used in perfuming bases cannot be exhaustive, but it has to be mentioned that the ingredients are well known to a person skilled in the art. However, one may cite as specific non-limiting examples the following: viscosity agents (e.g. surfactants, thickeners, gelling and/or rheology modifiers), stabilizing agents (e.g. preservatives, antioxidants, heat/light and or buffers or chelating agents, such as BHT), coloring agents (e.g. dyes and/or pigments), preservatives (e.g. antibacterial or antimicrobial or antifungal or anti-irritant agents), abrasives, skin cooling agents, fixatives, insect repellants, ointments, vitamins and mixture thereof.

In a particular embodiment, the at least one perfume compound is encapsulated. The at least one perfume compound can be encapsulated, for example, in a core-shell microcapsule. It is understood that not only a single perfume compound, but also a mixture of perfume compounds can be encapsulated within one microcapsule.

Suitable materials for the encapsulation of perfume compounds have been widely described in the prior art. As non-limiting examples, the microcapsule shell can be aminoplast-based, polyurea-based or polyurethane-based.

In a particular embodiment, the perfuming composition is present in the textile carrier layer and/or in the non-textile coating layer. Preferably, the perfuming composition is present in the non-textile coating layer. Preferably, the perfuming composition is incorporated within the non-textile coating layer.

In a particular embodiment, the textile article further comprises at least one agent selected from the group consisting of an anti-static agent, a dye transfer inhibitor, a whitening agent, an enzyme, a stain repellent, a wrinkle reducing agent, and a fabric softener agent.

The fabric softener agent can comprise a cationic nitrogen-containing compounds such as a quaternary ammonium compound. Generally, the fabric softener agent can comprise suitable cationic, anionic, nonionic, and zwitterionic compounds. Suitable fabric softener agents are well known to a skilled person.

Anti-static agents minimize or dissipate the accumulation of electrical charge. Examples for anti-static agents are quaternary ammonium salts, aliphatic amines, phosphate esters, and ethylene glycols.

A dye transfer inhibitor is an agent that prevents the transfer of a dye from one textile to another textile. Dye transfer inhibitors are mostly polymers and can be found in various classes of substances; for example, polyvinylpyrrolidones or polyimidazoles may be used.

Further, a skilled person is also aware of suitable whitening agents, enzymes, stain repellents, wrinkle reducing agents that may further be present in the textile article.

In a particular embodiment, the textile article further comprises a protective overprint layer on top of the non-textile coating layer. The protective overprint layer may comprise a PEG (polyethylene glycol) solution, wherein the PEG solution may be at a concentration of 60% in water.

Another aspect of the invention relates to a method for the preparation of a textile article according to the invention, comprising the step of adding an effective amount of the pro-perfume compound according to formula (I) to a textile article.

In a particular embodiment, an effective amount of pro-perfume compound refers to an amount of pro-perfume compound of from 0.000086 to 1.875 wt. %, based on the total weight of the textile article, preferably from 0.000086 to 1.5 wt. %, more preferably from 0.000086 to 1 wt. %, even more preferably from 0.000086 to 0.75 wt. %, yet even more preferably from 0.001 to 0.375, most preferably from 0.0172 to 0.1875 wt. %.

In a particular embodiment, the pro-perfume compound according to formula (I) is incorporated into the textile carrier layer of the textile article.

In a particular embodiment, the pro-perfume compound according to formula (I) is incorporated into the non-textile coating layer and/or applied on the surface of the coating layer.

Preferably, the pro-perfume compound according to formula (I) is incorporated into the non-textile coating layer.

When the pro-perfume compound is incorporated into the non-textile coating layer, the pro-perfume compound is preferably added to the coating layer before the coating layer comprising the pro-perfume compound is applied on the surface of the textile carrier layer. This can be done e.g. by melting the coating layer and adding the pro-perfume compound into the melt.

When the pro-perfume compound is applied on the surface of the non-textile coating layer, the pro-perfume compound is preferably sprayed on the surface of the coating layer.

In a particular embodiment, the method further comprises a step of applying a protective overprint layer on top of the non-textile coating layer. Preferably, the protective overprint layer comprises a PEG (polyethylene glycol) solution.

In a particular embodiment, the method further comprises a step of adding at least one agent selected from the group consisting of an anti-static agent, a dye transfer inhibitor, a whitening agent, an enzyme, a stain repellent, a wrinkle reducing agent, and a fabric softener agent. The agent may be incorporated into the textile carrier layer, into the non-textile coating layer and/or applied on the surface of the coating layer.

In a particular embodiment, the pro-perfume compound is not added to the textile article by means of a washing process. In other words, the pro-perfume is not added to the textile article by deposition of the pro-perfume compound onto the textile article during a washing process.

Another aspect of the invention relates to the use of the textile article according to the invention for improving, enhancing, conferring and/or modifying the fragrance impression and/or fragrance intensity of a garment during tumble-drying.

Under garment every piece of cloth or laundry is understood that can be dried in a tumble drier.

In a particular embodiment, tumble-drying is conducted at a temperature of from 45 to 70° C.

In a particular embodiment, the pro-perfume according to formula (I) is transferred from the textile article to the garment during tumble-drying. As a result, the pro-perfume according to formula (I) adheres to the tumble-dried garment.

Another aspect of the invention relates to a method for improving, enhancing, conferring and/or modifying the fragrance impression and/or fragrance intensity of a garment, comprising the step of adding the textile article according to the invention to a garment during tumble-drying.

### EXAMPLES

### Example 1

### Preparation of a Perfuming Composition Comprising Pro-Perfumes:

A perfuming composition was prepared by admixing the ingredients according to Table 1 below:

| Ingredient | wt. % |
|---|---|
| Isopropyl myristate | 32.1 |
| 1,4-dioxacycloheptadecane-5,17- | 12.5 |
| dione | |
| 1-oxa-12/13-cyclohexadecen-2-one | 6.4 |
| 2-(2-methyl-2-propanyl)cyclohexyl | 5.3 |
| acetate | |
| (3Z)-3-hexen-1-yl salicylate | 5.1 |
| 3-(dodecylthio)-1-(2,6,6- | 2.1 |
| trimethylcyclohex-3-en-1-yl)butan-1- | |
| one | |
| 4-(dodecylthio)-4-(2,6,6- | 2.1 |
| trimethylcyclohex-1/2-en-1-yl)butan-2- | |
| one | |
| (2E)-2-benzylideneoctanal | 3.4 |
| 1-(1,2,8,8-tetramethyl-1,3,4,5,6,7- | 3.2 |
| hexahydronaphthalen-2-yl)ethanone | |
| Methyl 2-((1RS,2RS)-3-oxo-2- | 3.0 |
| pentylcyclopentyl)acetate | |
| 1,1-dimethyl-2-phenylethyl butanoate | 2.1 |
| 4-(4-hydroxyphenyl)-2-butanone | 1.9 |
| Allyl heptanoate | 1.9 |
| (−)-(2E)-2-ethyl-4-[(1R)-2,2,3-trimethyl- | 1.7 |
| 3-cyclopenten-1-yl]-2-buten-1-ol | |
| 3-ethoxy-4-hydroxybenzaldehyde | 1.6 |
| 4-methoxybenzaldehyde | 1.6 |
| (+−)-4-decanolide | 1.5 |
| (+−)-3,7-dimethyl-1,6-octadien-3-ol | 1.5 |
| (+−)-5-heptyldihydro-2(3H)-furanone | 1.3 |
| Tricyclo[5.2.1.0(2,6)]dec-3/4-en-8-yl | 1.2 |
| propanoate | |
| (+−)-1,5-dimethyl-1-vinyl-4-hexenyl | 1.1 |
| acetate | |
| (10E)-oxacycloheptadec-10-en-2-one | 1.1 |
| Dipropylene glycol | 1.5 |
| 3-pentyltetrahydro-2H-pyran-4-yl | 0.8 |
| acetate | |
| (+−)-(3E)-4-(2,6,6-trimethyl-1/2- | 0.7 |
| cyclohexen-1-yl)-3-buten-2-one | |
| 2-ethyl-3-hydroxy-4(4h)-pyranone | 0.7 |
| Ethyl 2-methyl-1,3-dioxolane-2- | 0.6 |
| acetate | |
| Allyl 3-cyclohexylpropanoate | 0.5 |
| 1,1-dimethyl-2-phenylethyl acetate | 0.4 |
| Methyl 2,4-dihydroxy-3,6- | 0.3 |
| dimethylbenzoate | |
| Beta-pinene | 0.3 |
| (3E)-4-(2,6,6-trimethyl-1-cyclohexen- | 0.3 |
| 1-yl)-3-buten-2-one | |
| (+−)-(2E)-1-(2,6,6-trimethyl-2- | 0.2 |
| cyclohexen-1-yl)-2-buten-1-one | |

As pro-perfume compounds the perfuming composition comprises 3-(dodecylthio)-1-(2,6,6-trimethylcyclohex-3-en-1-yl) butan-1-one, 4-(dodecylthio)-4-(2,6,6-trimethyl-1-cyclohexen-1-yl)-2-butanone and 4-(dodecylthio)-4-(2,6,6-trimethylcyclohex-2-en-1-yl) butan-2-one.

### Preparation of a Perfumed Tumble Dryer Sheet:

Methyl bis[ethyl(tallowate)]-2-hydroxyethyl ammonium methyl sulfate (softening active) was melted at 65° C. and the perfuming composition according to Table 1 was incorporated into the melt at 5 wt. % under stirring. The molten mixture was then evenly applied on the surface of a pre-cut sheet of non-woven fabric (weight of the sheet was 0.65 g) held on a hot plate.

The non-woven fabric was coated with a total amount of melt of 1.3 g. Hence, the total weight of the final perfumed tumble dryer sheet was 1.95 g.

### Washing and Drying Cycle:

Cotton towels (25 pieces, each having a size of approximately 33 cm×33 cm, each weighing about 50 g) were washed with an unperfumed detergent (50 g) in a General Electric stackable washer/dryer at a light whites/medium setting.

The towels were then dried with either a non-perfumed dryer sheet or a perfumed dryer sheet. The perfumed dryer sheet is the dryer sheet mentioned above comprising the perfuming composition according Table 1. After drying, the towels were stored in bins. Dried towel samples were randomized and blind-coded. Screened and experienced panelists were then instructed to evaluate overall fragrance intensity of each sample (towel) on an unlabeled continuous line scale, wherein 0=no perceptible odor and 10=very strong odor.

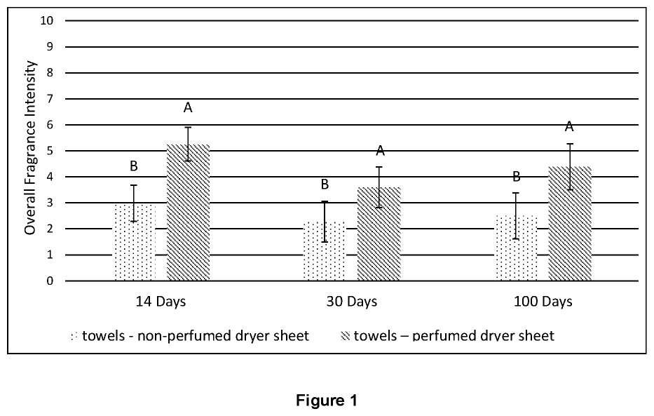

Sensorial evaluations were conducted at three time points (after 14 days, 30 days, and 100 days). The results are given in FIG. 1. For each time point, a significantly higher fragrance intensity was perceived for the towels that were dried with the perfumed dryer sheet compared to the non-perfumed dryer sheet (see FIG. 1). For each time point, the left columns in FIG. 1 refer to the fragrance intensity of towels that were dried with non-perfumed dryer sheet and the right columns refer to the fragrance intensity of towels that were dried with perfumed dryer sheet.

Even 100 days after drying and storage, a significantly higher intensity could be perceived for the towels that were dried with a perfumed dryer sheet compared to the towels that were dried with a non-perfumed dryer sheet. After this long time, it can be validly assumed that the higher fragrance intensity observed for the towels that were dried with the perfumed dryer sheet is not based on the mere presence of perfume compounds, but rather based on the presence of the pro-perfume compounds 3-(dodecylthio)-1-(2,6,6-trimethylcyclohex-3-en-1-yl) butan-1-one and 4-(dodecylthio)-4-(2,6,6-trimethylcyclohex-1/2-en-1-yl) butan-2-one (as given in Table 1), as it can be expected that regular volatile perfume compounds will not have a significant effect on the overall fragrance intensity any more after such prolonged storage times. By contrast, the pro-perfume compounds release the perfume compounds successively and thus provide the towels that were dried with perfumed dryer sheets with a long-term fragrance impression.

### Example 2

A tumble dryer sheet has been prepared as described in Example 1. In said perfumed tumble dryer sheet the perfuming composition is thus comprised in the non-textile coating layer. This sample is referred to as the Coating Sample (C-sample).

In addition, a perfumed tumble dryer sheet has been prepared by directly applying the perfuming composition as described in Table 1 of Example 1 onto a pre-cut sheet of non-woven fabric (weight of the sheet was 0.65 g). The amount of perfuming composition added onto the fabric was 0.065 g, which equals the amount of perfuming composition that is present in the coating layer of the C-sample. The sample thus prepared comprises the perfuming composition in the textile carrier layer and is referred to as the Textile Sample (T-sample).

Cotton towels (25 pieces, each having a size of approximately 33 cm×33 cm, each weighing about 50 g) were washed as described in Example 1.

The towels were then dried as described in Example 1 with either the C-sample or the T-sample.

After drying, the towels were stored in bins for seven days. Dried towel samples were randomized and blind-coded. Screened and experienced panelists (n=24) were then instructed to evaluate which one of the dried towel samples had a stronger fragrance intensity, i.e. the panelists had to decide whether the towels dried with the C-sample or the towels dried with the T-sample were perceived as having a stronger fragrance intensity. 17 out of the 24 panelists selected the towel samples dried with the C-sample as having a stronger fragrance intensity; only 7 panelists selected the towel samples dried with the T-sample as having a stronger fragrance intensity. Hence, it has been found that the perfumed tumble dryer sheet that comprised the pro-perfume compounds in the non-textile coating layer (C-sample), resulted in a significantly higher fragrance intensity (significance level of 95%) as compared to the perfumed tumble dryer sheet that comprised the pro-perfume compounds in the textile carrier layer (T-sample).

Hence, it is has been found that it is particularly beneficial for the fragrance delivery performance when the pro-perfume compounds are present in a non-textile coating layer.

### Example 3

A perfumed tumble dryer sheet according to the invention has been prepared as described in Example 1. However, instead of using the perfuming composition according to Table 1, the perfuming composition according to Table 2 has been used as given below:

| Ingredient | wt. % |
|---|---|
| Dipropylene glycol | 13.61 |
| (2E)-2-benzylideneoctanal | 8.37 |
| oxacyclohexadecan-2-one | 7.18 |
| 1-(1,2,3,4,5,6,7,8-octahydro- | 7.10 |
| 2,3,8,8-tetramethyl-2- | |
| naphtyl)ethan-1-one and isomers | |
| 3-(dodecylthio)-1-(2,6,6- | 5.50 |
| trimethylcyclohex-3-en-1-yl)butan-1- | |
| one | |
| 4-methyl-2-(2-methylpropyl)oxan-4-ol | 5.32 |
| benzyl 2-hydroxybenzoate | 4.14 |
| benzyl acetate | 3.31 |
| 1-naphthalen-2-ylethanone | 2.72 |
| 2,6-dimethyloct-7-en-2-ol | 2.45 |
| Tricyclo[5.2.1.0(2,6)]dec-3/4-en-8-yl | 2.40 |
| propanoate | |
| 2-(2-methyl-2-propanyl)cyclohexyl | 2.32 |
| acetate | |
| 2,6-dimethyl-2-octanol | 2.22 |
| 2-phenylethanol | 2.22 |
| 3,7-dimethylocta-1,6-dien-3-yl acetate | 2.20 |
| (+−)-5-heptyldihydro-2(3H)-furanone | 2.18 |
| (−)-(2E)-2-ethyl-4-[(1R)-2,2,3-trimethyl- | 2.08 |
| 3-cyclopenten-1-yl]-2-buten-1-ol | |
| 4-hydroxy-3-methoxybenzaldehyde | 1.75 |
| (E)-4-methyldec-3-en-5-ol | 1.70 |
| 3,7-dimethyloct-6-en-1-ol | 1.61 |
| (2-methyl-1-phenylpropan-2-yl) | 1.41 |
| butanoate | |
| 2-(4-methylcyclohex-3-en-1-yl)propan- | 1.81 |
| 2-yl acetate | |
| methyl 2,4-dihydroxy-3,6- | 1.23 |
| dimethylbenzoate | |
| 10-undecenal | 1.18 |
| 3-(4-isopropylphenyl)-2- | 1.13 |
| methylpropanal | |
| (E)-1-(2,6,6-trimethylcyclohex-3-en-1- | 1.11 |
| yl)but-2-en-1-one | |
| 2-phenoxyethyl 2-methylpropanoate | 1.02 |
| 3-methyl-4/5-cyclopentadecen-1-one | 0.95 |
| (3E)-4-(2,6,6-trimethyl-1-cyclohexen- | 0.81 |
| 1-yl)-3-buten-2-one | |
| cyclohexyl 2-hydroxybenzoate | 0.81 |
| 4-methyl-2-(2-methylprop-1- | 0.79 |
| enyl)oxane | |
| triethyl 2-hydroxypropane-1,2,3- | 0.78 |
| tricarboxylate | |
| (10E)-oxacycloheptadec-10-en-2-one | 0.71 |
| 1-phenylethyl acetate | 0.67 |
| 4-allyl-2-methoxyphenol | 0.66 |
| 1,1-dimethyl-2-phenylethyl acetate | 0.65 |
| 4-methoxybenzaldehyde | 0.63 |
| 5-hexyloxolan-2-one | 0.60 |
| (2E)-3,7-dimethylocta-2,6-dien-1-ol | 0.59 |
| (2,5-Dimethyl-1,3-dihydroinden-2- | 0.58 |
| yl)methanol | |
| methyl 2-(3-oxo-2- | 0.52 |
| pentylcyclopentyl)acetate | |
| 5-pentyloxolan-2-one | 0.51 |
| methyl 2-aminobenzoate | 0.43 |

Moreover, a control tumble dryer sheet has been prepared the same way as described for the tumble dryer sheet according to the invention. However, for the preparation of the control tumble dryer sheet the perfuming composition according to Table 2 was modified in that the pro-perfume compounds 3-(dodecylthio)-1-(2,6,6-trimethylcyclohex-3-en-1-yl) butan-1-one were replaced by dipropylene glycol, i.e. in the perfuming composition used for the control tumble dryer sheet, the aforementioned pro-perfume compounds and their respective amounts (in total 5.5 wt. %) have been replaced by dipropylene glycol.

The tumble dryer sheet according to the invention and the control tumble dryer sheet were then used during the drying of cotton towels two times in a row to assess the reusability of the tumble dryer sheet according to the invention.

### First Washing and Drying Cycle:

A first set of cotton towels (25 pieces, each having a size of approximately 33 cm×33 cm, each weighing about 50 g) was washed as described in Example 1.

The towels were then dried as described in Example 1 with either the tumble dryer sheet according to the invention or the control tumble dryer sheet.

After drying, the towels were stored in bins for seven days. Dried towel samples were randomized and blind-coded. Screened and experienced panelists (n=26) were then instructed to evaluate which one of the dried towel samples had a stronger fragrance intensity, i.e. the panelists had to decide whether the towels dried with the tumble dryer sheet according to the invention or dried with the control tumble dryer sheet were perceived as having a stronger fragrance intensity. 18 out of the 26 panelists selected the towel samples dried with the tumble dryer sheet according to the invention as having a stronger fragrance intensity; only 8 panelists selected the towel samples dried with the control tumble dryer sheet as having a stronger fragrance intensity. Hence, it has been found that the tumble dryer sheet according to the invention that comprised pro-perfume compounds resulted in a significantly higher fragrance intensity (significance level of 95%) as compared to the control tumble dryer sheet that did not comprise pro-perfume compounds.

### Second Washing and Drying Cycle:

A second set of cotton towels (25 pieces, each having a size of approximately 33 cm×33 cm, each weighing about 50 g) was washed as described in Example 1.

Both the tumble dryer sheet according to the invention and the control tumble dryer sheet were used again during the drying of the second set of cotton towels. The drying has been performed as described in Example 1.

After drying, the towels were stored in bins for seven days. Dried towel samples were randomized and blind-coded. Screened and experienced panelists (n=26) were then instructed to evaluate which one of the dried towel samples had a stronger fragrance intensity, i.e. the panelists had to decide whether the towels dried with the reused tumble dryer sheet according to the invention or dried with the reused control tumble dryer sheet were perceived as having a stronger fragrance intensity. 24 out of the 26 panelists selected the towel samples dried with the tumble dryer sheet according to the invention as having a stronger fragrance intensity; only 2 panelists selected the towel samples dried with the control tumble dryer sheet as having a stronger fragrance intensity. Hence, it has been found that the tumble dryer sheet according to the invention that comprised pro-perfume compounds resulted in a significantly higher fragrance intensity (significance level of 99%) as compared to the control tumble dryer sheet that did not comprise pro-perfume compounds upon repeated use of the tumble dryer sheets.

Hence, it has been found that the tumble dryer sheet according to the invention is suitable for repeated use while still delivering sufficient fragrance intensity.

1. A textile article comprising a pro-perfume compound, wherein the pro-perfume compound is a compound of formula 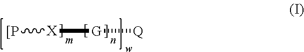
wherein:
a) w represents an integer from 1 to 10000;
b) n represents 1 or 0;
c) m represents an integer from 1 to 6;
d) P represents a hydrogen atom or a radical susceptible of generating an odoriferous α,β-unsaturated ketone, aldehyde or carboxylic ester and is represented by the formula 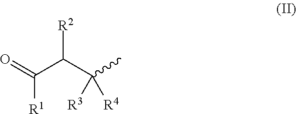
in which the wavy line indicates the location of the bond between said P and X; R¹ represents a hydrogen atom, a C₁ to C₆ alkoxyl radical or a C₁ to C₁₅ linear, cyclic or branched alkyl, alkenyl or alkadienyl radical, optionally substituted by one to four C₁ to C₄ alkyl groups; and
R², R³ and R⁴ represent independently of each other a hydrogen atom, an aromatic ring, or a C₁ to C₁₅ linear, cyclic or branched alkyl, alkenyl or alkadienyl radical, possibly substituted by C₁ to C₄ alkyl groups; or two, or three, of the groups R¹ to R⁴ are bonded together to form a saturated or unsaturated ring having 5 to 20 carbon atoms and including the carbon atom to which said R¹, R², R³ or R⁴ groups are bonded, this ring being optionally substituted by C₁ to C₈ linear, branched or cyclic alkyl or alkenyl groups; and with the proviso that at least one of the P groups is of the formula (II) as defined hereinabove;
e) X represents, independently from each other, a functional group selected from the group consisting of the formulae i) to xiv): 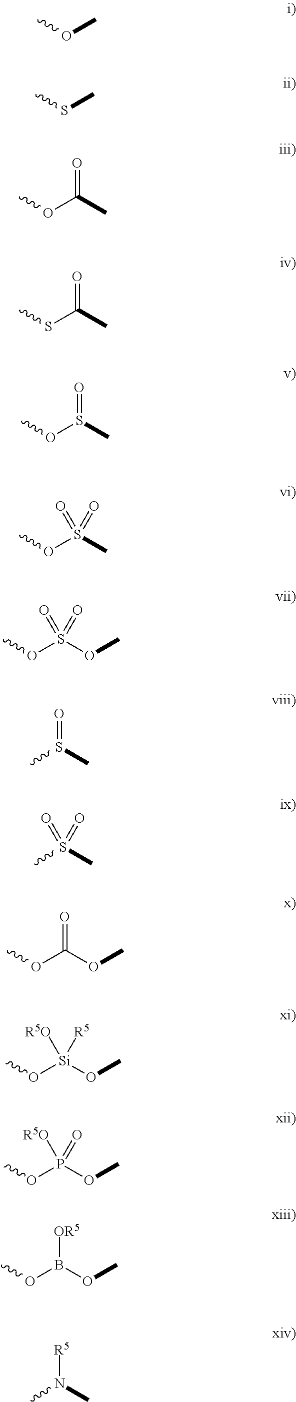
in which formulae the wavy lines are as defined previously and the bold lines indicate the location of the bond between said X and G, and R⁵ represents a hydrogen atom, a C₁ to C₂₂, saturated or unsaturated, alkyl group or an aryl group, optionally substituted by C₁ to C₆ alkyl or alkoxyl groups or halogen atoms; and with the proviso that X may not exist when P represents a hydrogen atom;
f) G represents a multivalent radical (with a m+1 valence) derived from cyclic, linear, alicyclic or branched alkyl, cyclic, linear, alicyclic or branched alkenyl, phenyl, alkylphenyl or alkenylphenyl hydrocarbon radical having from 1 to 22 carbon atoms, said hydrocarbon radical being optionally substituted and containing from 1 to 10 functional groups selected from the group consisting of halogens, alcohols, ethers, esters, ketones, aldehydes, carboxylic acids, thiols, thioethers, amines, quaternary amines and amides; and
g) Q represents a hydrogen atom (in which case w=1 and n=1), or represents a polymer or co-polymer selected from the group consisting of poly(alkylimine) s, peptides (e.g. lysine) or polysaccharides selected from the group consisting of cellulose, cyclodextrins and starches, or cationic quaternised silicon polymers, or still a polymer or random co-polymer derived from monomeric units selected from the group consisting of the formulae A-1), A-2), A-3), B-1), B-2), C-1), C-2), and C-3): 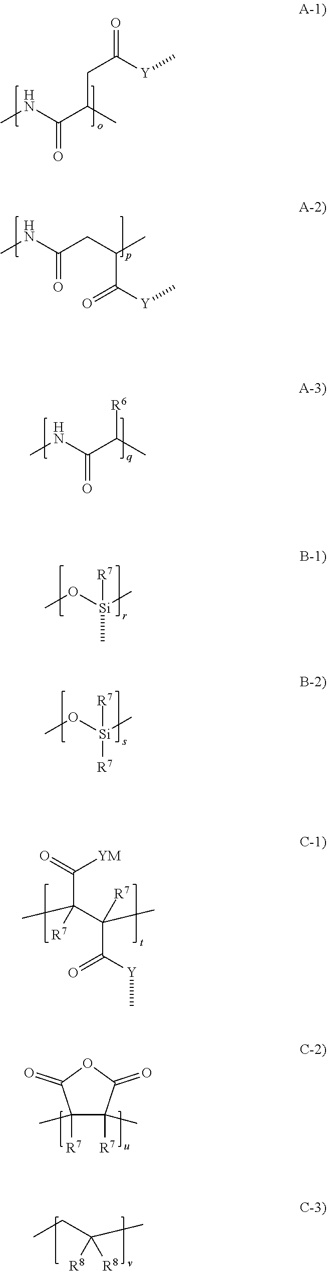
wherein the hatched lines indicate the location of the bond between said monomeric unit and G;
Y represents an oxygen or sulfur atom or a NR⁷ group;
o, p, q, r, s, t, u and v all represent independent of each other fractions between 0 and 1, with o+p+q=1, r+s=1 and t+u+v=1 and with the proviso that either o or p, as well as r and t are not equal to 0;
R⁶ represents a hydrogen atom or a side chain from a natural or unnatural amino acid, such as glycine, alanine, phenylalanine, arginine, histidine, lysine, aspartic acid, glutamic acid, cysteine, methionine, glutamine, asparagine, threonine, serine, leucine, isoleucine, valine, tyrosine or tryptophan;
R⁷ represents, simultaneously or independently, a hydrogen atom or a C₁-C₁₆ hydrocarbon group;
R⁸ represents, simultaneously or independently of each other
a hydrogen or halide atom;
a C₁-C₆ hydrocarbon group optionally comprising from 1 to 4 heteroatoms selected from the group consisting of oxygen and sulfur atoms;
a carboxylic group of formula COOR*, wherein R* represents a hydrogen atom, a C₁-C₆₀ alkyl or alkenyl group optionally comprising from 1 to 30 oxygen atoms;
a OR⁷ group or a COR⁷ group; or
a pyrrolidone unit, connected by the nitrogen atom; and
M represents a hydrogen atom, an alkali or earth alkali metal ion.

2. The textile article of claim 1, wherein the pro-perfume compound of formula (I) is characterized in that
w=1; n=1; m=1;
P represents a radical susceptible of generating an odoriferous α,β-unsaturated ketone, aldehyde and is represented by the formula, 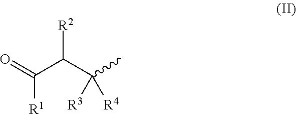
Wherein R¹ has the same meaning as defined in claim 1, R², R³ and R⁴ represent independently of each other a hydrogen atom, a C₆ to C₁₀ aromatic ring, or a C₁ to C₁₅ linear, cyclic or branched alkyl, alkenyl or alkadienyl radical, optionally-possibly substituted by C₁ to C₄ alkyl groups; or two, or three, of the groups R¹ to R⁴ are bonded together to form a saturated or unsaturated ring having 5 to 20 carbon atoms and including the carbon atom to which said R¹, R², R³ or R⁴ groups are bonded, this ring being optionally possibly substituted by C₁ to C₈ linear, branched or cyclic alkyl or alkenyl groups;
X represents formula ii)
G represents a divalent radical derived from cyclic, linear or branched alkyl, alkenyl, phenyl, alkylphenyl or alkenylphenyl hydrocarbon radical having from 2 to 8 carbon atoms optionally comprising 1 or 2 oxygen, sulfur and/or nitrogen atoms
Q represents a polymer or random co-polymer derived from formula B-1), wherein R⁷ represents a C₁-C₁₆ hydrocarbon group.

3. The textile article of claim 1-er-2, wherein the pro-perfume compound is either selected from the group consisting of formulae a) to d): 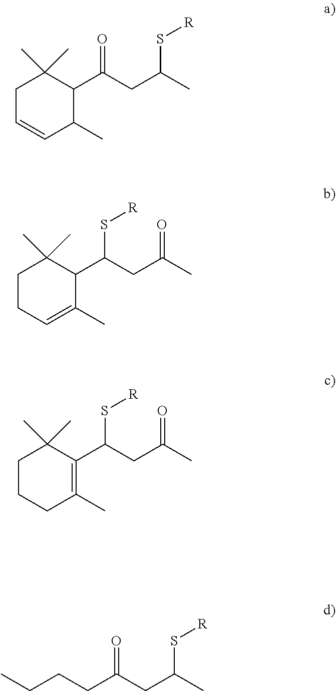
wherein R represents a C₁-C₂₀ alkyl or alkenyl group;
or wherein the pro-perfume compound is a linear polysiloxane co-polymer comprising at least one repeating unit of formula 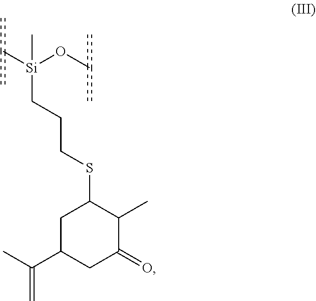
wherein the double hatched lines indicate the bonding to another repeating unit.

4. The textile article according to claim 1, wherein the pro-perfume compound is selected from the group consisting of 3-(dodecylthio)-1-(2,6,6-trimethylcyclohex-3-en-1-yl) butan-1-one, 2-(dodecylthio)-4-octanone, 2-(dodecylsulfonyl) octan-4-one, 3-(dodecylthio)-1-(2,6,6-trimethylcyclohex-2-en-1-yl) butan-1-one, 4-(dodecylthio)-4-(2,6,6-trimethylcyclohex-2-en-1-yl) butan-2-one, and 4-(dodecylthio)-4-(2,6,6-trimethylcyclohex-1-en-1-yl) butan-2-one, 4-(dodecylthio)-4-methylpentan-2-one, methyl or ethyl N,S-bis(4-oxo-4-(2,6,6-trimethylcyclohex-3-en-1-yl) butan-2-yl)-L-cysteinate, methyl or ethyl S-(4-oxo-4-(2,6,6-trimethylcyclohex-3-en-1-yl) butan-2-yl)-L-cysteinate, 4-oxooctan-2-yl dodecanoate or any mixture thereof.

5. The textile article according to claim 1, wherein the pro-perfume compound is non-encapsulated.

6. The textile article according to claim 1, wherein the textile article comprises a textile carrier layer and a non-textile coating layer.

7. The textile article of claim 6, wherein the pro-perfume compound is present in the textile carrier layer and/or in the non-textile coating layer.

8. The textile article according to claim 1, wherein the article comprises the pro-perfume compound in an amount of from 0.000086 to 1.875 wt. %, based on the total weight of the article.

9. The textile article according to claim 1, wherein the textile article further comprises a perfuming composition comprising
i) at least one ingredient selected from the group consisting of a perfumery carrier and a perfumery base; and
ii) optionally at least one perfumery adjuvant.

10. The textile article of claim 9, wherein the perfuming composition is present in the non-textile coating layer.

11. The textile article according to claim 1, wherein the textile article is a tumble dryer sheet, a dryer ball, a dryer sachet or a wipe, preferably a tumble dryer sheet.

12. The textile article according to claim 1, wherein the textile article comprises at least one agent selected from the group consisting of an anti-static agent, a dye transfer inhibitor, a whitening agent, an enzyme, a stain repellent, a wrinkle reducing agent, and a fabric softener agent.

13. A method for the preparation of a textile article as defined in claim 1, comprising the step of adding an effective amount of a pro-perfume compound according to formula (I) to a textile article.

14. (canceled)

15. A method for improving, enhancing, conferring and/or modifying the fragrance impression and/or fragrance intensity of a garment, comprising the step of adding the textile article as defined in claim 1 to a garment during tumble-drying.

16. The textile article according to claim 8, wherein the article comprises the pro-perfume compound in an amount of from 0.001 to 0.375 wt. %, based on the total weight of the article.

17. The textile article according to claim 8, wherein the article comprises the pro-perfume compound in an amount of from 0.0172 to 0.1875 wt. %, based on the total weight of the article.
